(19) United States
(12) Patent Application Publication
(10) Pub. No.: US 2024/0296143 A1
(43) Pub. Date: Sep. 5, 2024

(54) METHOD AND COMPUTER DEVICE FOR MERGING MULTI-FORMAT FILES INTO ONE OFD FILE

(71) Applicant: JIANGSU TRUEWAY TECHNOLOGY SOFTWARE SYSTEM CO., LTD., Nantong (CN)

(72) Inventors: Ranran He, Nantong (CN); Zhong He, Nantong (CN); Yajun Cai, Nantong (CN); Chao Gong, Nantong (CN); Wei Yan, Nantong (CN); Zhiping Gu, Nantong (CN); Hailin Ju, Nantong (CN); Donghai Shi, Nantong (CN)

(21) Appl. No.: 18/651,368

(22) Filed: Apr. 30, 2024

Related U.S. Application Data
(63) Continuation-in-part of application No. PCT/CN2022/129945, filed on Nov. 4, 2022.

(30) Foreign Application Priority Data
Nov. 5, 2021 (CN) 202111305218.4

(51) Int. Cl. G06F 16/11

(52) U.S. Cl. CPC G06F 16/116

(57) ABSTRACT

The present application discloses a method and a computer device for merging multi-format files into a single OFD file, which involves converting multi-format files into standard OFD files; creating a basic OFD file structure; extracting multiple OFD files to generate an extracted folder; smoothly copying in sequence OFD file resources into the basic OFD file structure according to a configuration of the OFD file structure; sequentially replacing resources if there are duplicate resource IDs, and generating a unified merged OFD file. The method described in the present application can be used to merge multi-format files to generate an OFD format file with a unified format and a standardized display, making it easy for multiple files with the same or different formats to be archived, forwarded, read, and shared in a unified format as a whole.

### CROSS-REFERENCE

This application is a continuation of International Patent Application No. PCT/CN2022/129945 with a filing date of Nov. 4, 2022, designating the United States, now pending, and further claims priority to Chinese Patent Application No. 202111305218.4 with a filing date of Nov. 5, 2021. The content of the aforementioned applications, including any intervening amendments thereto, are incorporated herein by reference.

### TECHNICAL FIELD

The present application refers to a technical field of merging and displaying, and particular to a method and a device for merging multi-format files into an OFD file.

### BACKGROUND

Currently, a merging of multiple files is achieved by parsing and rendering through a reading device without damaging an original text, so that the multiple files are merged into one file, which can be read together. However, a merged file actually still includes multiple files and only a way of reading the files is changed, which is inconvenient for offline storing, sharing, forwarding, and reading the files.

On Oct. 14, 2016, World Standards Day, the Standardization Administration of China officially approved a release of the national standard GB/T 33190-2016 Electronic files storage and exchange formats—Fixed layout documents based on independent technology. OFD, short for Open Fixed-layout Document, is an independent and controllable technology in China for electronic document format, and its corresponding international standard is PDF. With fixed layout, non-second display, and what you see is what you get, OFD files can be regarded as a “digital paper” of a computer age and an ideal document format for electronic document publishing, digital information dissemination and archiving. There was no unified national or industrial standard for archiving formats of electronic file in the past. With easy modification of the content and security risks in transfer process, unfixed layout documents, such as DOC, WPS, PPTX, etc. used in archives work do not meet the requirements for long-term storage of electronic files.

### BRIEF DESCRIPTION OF ATTACHED FIGURES

FIG. 1 is a flowchart of a method for merging multi-format files into an OFD file provided by some embodiments of the present application.

FIG. 2 is a hierarchical organization structure of the OFD file.

### DETAILED DESCRIPTION

### Explanation

An essence of an OFD file is a compressed package of XML files.

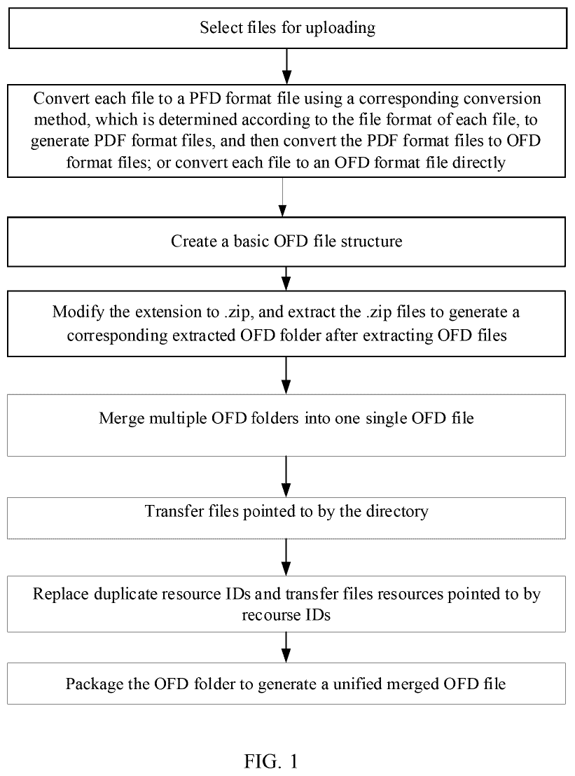

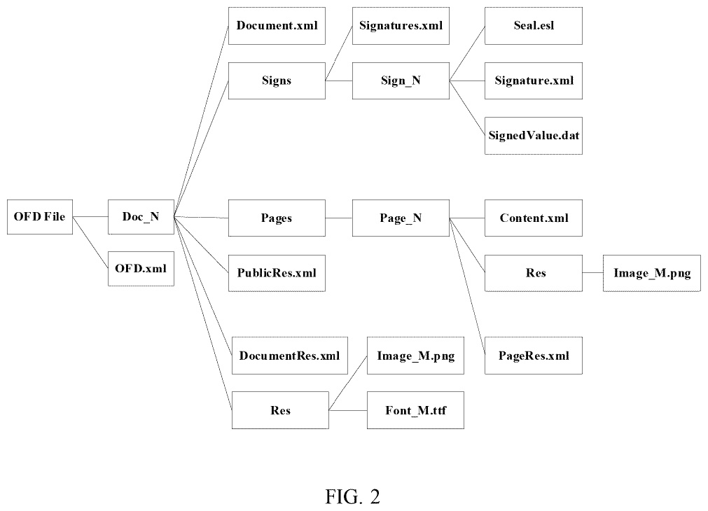

In some embodiments of the present application, a system for merging multi-format files into a single OFD file includes at least one client and a server. Combining a content shown in FIG. 1, a method of using the system to merge multi-format files into the single OFD file includes following steps:
Step 1. The client selects files for uploading, and file formats of the files that are uploaded include but are not limited to wps, doc/docx, xls/xlsx, ppt/pptx, cad, jpg, tif, gif, png, pdf and html;
Step 2. The server receives the files uploaded by the client, determines a file format of each of the files, converts each file to an PDF format file using a corresponding conversion method, which is determined according to the file format of each file, to generate PDF format files, and then converts the PDF format files to OFD format files; or converts each file to an OFD format file directly. Converting each file to the PFD format file using the corresponding conversion method includes following:
1) Files in formats of wps and doc/docx are converted to PDF format files using Word.Application.
2) Files in format of xls/xlsx are converted to PDF format files using Excel.Application.
3) Files in format of ppt/pptx are converted to PDF format files using PowerPoint.Application.
4) Files in format of cad are converted to PDF format files using Aspose.CAD. When layers in CAD drawings have different sizes, with an automatic scaling function, the layers can be scaled according to a unified page size in the PDF.
5) Images in formats of jpg, tif, gif, png are converted to PDF format files using PdfWriter.
Step 3. The server creates a basic OFD file structure, which has nothing but a structure;
Step 4. The server traverses a number of OFD files, and creates a new file directory, copies the traversed OFD files to the new file directory on the server, modifies the extensions of the OFD files in the new file directory from .ofd to .zip, and extracts the .zip files to generate an extracted OFD folder corresponding to OFD files. A hierarchical organization structure is shown in FIG. 2;
Step 5. The server smoothly copies file contents and file resources of the files in the folder into the basic OFD file structure in sequence, and packages the basic OFD file structure with all files and file resources within the basic OFD file structure to generate a unified merged OFD file, which involves the following steps:
Step 5.1. Merge directories of a number of OFD folders based on the basic OFD file structure. An OFD.xml file in an xml file package in the OFD folder is an entry file. The first OFD file is overwritten in the OFD.xml in the basic OFD file structure;
Step 5.2. Transfer the files pointed to by the directory. The server parses the files in a Doc-N directory in a same file directory, reads a document.xml file from the xml file package, and sequentially writes a content of ofd:Pages in the document.xml file to a corresponding xml in the basic OFD file structure. If there are same file paths in multiple OFD folders, the corresponding content of ofd:Page BaseLoc is adjusted.

For example, if the page number in file 1 ends at ‘<ofd:Page BaseLoc=“Pages/Page_11/Content.xml”ID=“12”/>’, accumulation should be continued from Pages_12, ID=13 for the merging of subsequent files, and each file should be copied to the corresponding page number.

If n file directories are all 1-10, then it is necessary to adjust the file directories of these folders. The adjusted directories are 1-10, 11-20, {(n−1)*10+1}−(n*10), and then the corresponding files pointed are copied into the adjusted directories. The script information is as follows:
<?Xml version=“1.0”encoding=“UTF-8”?>
   <ofd:Document xmlns:ofd=“http://www.ofdspec.org/2016”>
   <ofd:CommonData>
<ofd:MaxUnitID>6166</ofd:MaxUnitID>
   <ofd:PageArea>
<ofd:PhysicalBox>0 0 210 297</ofd:PhysicalBox>
</ofd:PageArea>
<ofd:PublicRes>PublicRes.xml</ofd:PublicRes>
</ofd:CommonData>
   <ofd:Pages>
<ofd:Page BaseLoc=“Pages/Page_0/Content.xml”ID=“1”/>
<ofd:Page BaseLoc=“Pages/Page_1/Content.xml”ID=“2”/>
<ofd:Page BaseLoc=“Pages/Page_2/Content.xml”ID=“3”/>
<ofd:Page BaseLoc=“Pages/Page_3/Content.xml”ID=“4”/>
<ofd:Page BaseLoc=“Pages/Page_4/Content.xml”ID=“5”/>
<ofd:Page BaseLoc=“Pages/Page_5/Content.xml”ID=“6”/>
<ofd:Page BaseLoc=“Pages/Page_6/Content.xml”ID=“7”/>
<ofd:Page BaseLoc=“Pages/Page_7/Content.xml”ID=“8”/>
<ofd:Page BaseLoc=“Pages/Page_8/Content.xml”ID=“9”/>
<ofd:Page BaseLoc=“Pages/Page_9/Content.xml”ID=“10”/>
<ofd:Page BaseLoc=“Pages/Page_10/Content.xml”ID=“11”/>
<ofd:Page BaseLoc=“Pages/Page_11/Content.xml”ID=“12”/>
</ofd:Pages>
</ofd:Document>
Step 5.3. Replace duplicate resource IDs. The server traverses a content.xml content of Pages and traverses the resource IDs starting from a first page, and copies the file resources pointed to by the IDs to the corresponding folder. If there is a duplicate ID, modify the duplicate ID, rename the file resources, and copy the file resources to corresponding xml file package in the OFD folder;
Step 5.4. Merge the file resources of the xml file packages in several OFD folders to form an xml file package, modify the extension of the xml file package to ofd, and generate a unified merged OFD file;
The file resources mentioned above include fonts, font sizes, images, text, etc;
Step 5.3 can be executed before step 5.2.

Merging multi-format files described above is a creation of OFD format files with unified format and standardized display, making it convenient for multiple files with the same or different formats to be archived, forwarded, read, and shared in a unified format as a whole.

Applying the method of merging multi-format files into the single OFD file mentioned above to merge OFD internal versioned files involves the following steps:
S1. Retrieve multiple OFD internal versioned files including file processing sheets, final drafts, and all previous revised drafts from Version.xml in a root directory;
S2. Convert the OFD internal versioned files to OFD format files;
S3. Create a basic OFD file structure;
S4. Traverse a number of OFD files, create a new file directory on the server, copy the traversed OFD files to the new file directory, modify the extensions of the OFD files in the new file directory from .ofd to .zip, and extract the .zip files to generate a corresponding extracted OFD folder;
S5. The server smoothly copies the file contents and file resources from the OFD folder into the basic OFD file structure in sequence, and packages the basic OFD file structure with all files and file resources within the basic OFD file structure to generate a unified merged OFD file, which involves the following steps:
Step 5.1. Merge the directories of multiple OFD folders based on the basic OFD file structure. The OFD.xml file is the entry file. The first OFD file is overwritten in the OFD.xml in the basic OFD file structure;
Step 5.2. Transfer files pointed to by the directory. The server parses the files in the Doc_N directory in the same file directory, reads the document.xml file from the xml file package, and writes in sequence the content of ofd:Pages in the document.xml file to corresponding xml in the basic OFD file structure. If multiple OFD files share a same file path, adjust the content of the corresponding ofd:Page BaseLoc;
Step 5.3. Replace duplicate resource IDs. The server traverses the content.xml content of Pages in the xml file package and the resource IDs starting from the first page, and copies the file resources pointed to by the IDs to the corresponding folder. If there is a duplicate ID, modify the duplicate ID, rename the file resources, and copy them to the corresponding OFD file folders.
Step 5.4. Package OFD folders, modify the extension of the xml file package to ofd to generate a unified merged OFD file.

Merging multiple OFD internal versioned files described above enables historical records of files to be merged as a whole, making it easier for multiple OFD internal versioned files to be archived, forwarded, read, and shared as a whole. For the generated electronic document content images, full-text content data and scanned images are merged into a double-layer OFD format file with OCR technology. The metadata of electronic archiving can be embedded into OFD files.

In some embodiments of the present application, a computer device for merging multi-format files into a single OFD file includes at least one storage medium and at least one processor.

The at least one storage medium is used for storing computer instructions.

The at least one processor is used for executing the computer instructions so as to carry out the method of merging multi-format files into the OFD file and/or the method of merging the OFD internal versioned files mentioned above.

The above is only a preferred mode for the present application. It should be pointed out that for ordinary skilled in the art, several similar modifications and improvements can also be made without departing from the creative concept of the present application, which should also be considered as the scope of protection for the present application.

What is claimed is:

1. A method for merging multi-format files into an open fixed-layout document (OFD) file, comprising:
converting multi-format files into OFD format files;
creating a basic OFD file structure;
extracting the OFD format files to generate an extracted folder;
copying file resources corresponding to the OFD format files into the basic OFD file structure, and packaging the basic OFD file structure with all files and file resources within the basic OFD file structure to generate a unified merged OFD file; a process of packaging comprising merging directories of the OFD format files and transferring files pointed to by the directories based on the basic OFD file structure as follows:
overwriting a first OFD file into an OFD.xml in the basic OFD file structure;
parsing files in a Doc_N directory in a same file directory, reading document.xml files, writing a content of ofd:Pages in the document.xml file to a corresponding xml in the basic OFD file structure, and adjusting a content of a corresponding ofd:Page BaseLoc when the OFD format files share a same file path.

2. The method of merging multi-format files into the OFD file according to claim 1, wherein the file formats comprise wps, doc/docx, xls/xlsx, ppt/pptx, cad, jpg, tif, gif, png, pdf, and html.

3. The method of merging multi-format files into the OFD file according to claim 1, wherein extracting the OFD file comprises:
modifying an extension of the OFD file from .ofd to .zip to generate a compressed file; and
extracting the compressed file to generate an extracted folder.

4. The method of merging multi-format files into the OFD file according to claim 1, wherein packaging the basic OFD file structure with all files and file resources within the basic OFD file structure to generate the unified merged OFD file comprises:
merging directories of the OFD format files and transferring files pointed to by the directories based on the basic OFD file structure;
replacing duplicate resource IDs and transferring relevant file resources;
packaging the extracted folder to generate a merged OFD format file.

5. The method of merging multi-format files into the OFD file according to claim 4, wherein replacing duplicate resource IDs and transferring relevant file resources comprise:
traversing resource IDs starting from a first page;
copying the file resources pointed to by the IDs to a corresponding folder;
if there is a duplicate ID, modifying the duplicate ID;
renaming the file resources and copying the file resources into the corresponding folder.

6. A system for merging multi-format files into an open fixed-layout document (OFD) file, comprising at least one client and a server:
the at least one client being used for uploading multi-format files, and receiving and displaying merged OFD format files;
the server being used for storing and executing computer instructions to carry out a method of merging the multi-format files into OFD files, wherein the method comprises:
converting multi-format files into OFD format files;
creating a basic OFD file structure;
extracting the OFD format files to generate an extracted folder;
copying file resources corresponding to the OFD format files into the basic OFD file structure, and packaging the basic OFD file structure with all files and file resources within the basic OFD file structure to generate a unified merged OFD file; a process of packaging comprising merging directories of the OFD format files and transferring files pointed to by the directories based on the basic OFD file structure as follows:
overwriting a first OFD file into an OFD.xml in the basic OFD file structure;
parsing files in a Doc_N directory in a same file directory, reading document.xml files, writing a content of ofd:Pages in the document.xml file to a corresponding xml in the basic OFD file structure, and adjusting a content of a corresponding ofd:Page BaseLoc when the OFD format files share a same file path.

7. The system according to claim 6, wherein the file formats comprise wps, doc/docx, xls/xlsx, ppt/pptx, cad, jpg, tif, gif, png, pdf, and html.

8. The system according to claim 6, wherein extracting the OFD file comprises:
modifying an extension of the OFD file from .ofd to .zip to generate a compressed file; and
extracting the compressed file to generate an extracted folder.

9. The system according to claim 6, wherein packaging the basic OFD file structure with all files and file resources within the basic OFD file structure to generate the unified merged OFD file comprises:
merging directories of the OFD format files and transferring files pointed to by the directories based on the basic OFD file structure;
replacing duplicate resource IDs and transferring relevant file resources;
packaging the extracted folder to generate a merged OFD format file.

10. The system according to claim 9, wherein replacing duplicate resource IDs and transferring relevant file resources comprise:
traversing resource IDs starting from a first page;
copying the file resources pointed to by the IDs to a corresponding folder;
if there is a duplicate ID, modifying the duplicate ID;
renaming the file resources and copying the file resources into the corresponding folder.

11. A computer device for merging multi-format files into an open fixed-layout document (OFD) file, comprising:
at least one storage medium, storing computer instructions; and
at least one processor, when the computer instructions are executed by the at least one processor, being caused to:
converting multi-format files into OFD format files;
creating a basic OFD file structure;
extracting the OFD format files to generate an extracted folder;
copying file resources corresponding to the OFD format files into the basic OFD file structure, and packaging the basic OFD file structure with all files and file resources within the basic OFD file structure to generate a unified merged OFD file; a process of packaging comprising merging directories of the OFD format files and transferring files pointed to by the directories based on the basic OFD file structure as follows:
overwriting a first OFD file into an OFD.xml in the basic OFD file structure;
parsing files in a Doc_N directory in a same file directory, reading document.xml files, writing a content of ofd:Pages in the document.xml file to a corresponding xml in the basic OFD file structure, and adjusting a content of a corresponding ofd:Page BaseLoc when the OFD format files share a same file path.

12. The computer device according to claim 11, wherein the file formats comprises wps, doc/docx, xls/xlsx, ppt/pptx, cad, jpg, tif, gif, png, pdf, and html.

13. The computer device according to claim 11, wherein the at least one processor extracts the OFD file by:
modifying an extension of the OFD file from .ofd to .zip to generate a compressed file; and
extracting the compressed file to generate an extracted folder.

14. The computer device according to claim 11, wherein the at least one processor packages the basic OFD file structure with all files and file resources within the basic OFD file structure to generate the unified merged OFD file by:
merging directories of the OFD format files and transferring files pointed to by the directories based on the basic OFD file structure;
replacing duplicate resource IDs and transferring relevant file resources;
packaging the extracted folder to generate a merged OFD format file.

15. The computer device according to claim 14, wherein the at least one processor replaces duplicate resource IDs and transfers relevant file resources by:
traversing resource IDs starting from a first page;
copying the file resources pointed to by the IDs to a corresponding folder;
if there is a duplicate ID, modifying the duplicate ID;
renaming the file resources and copying the file resources into the corresponding folder.
